(19) United States
(12) Patent Application Publication
(10) Pub. No.: US 2002/0104224 A1
(43) Pub. Date: Aug. 8, 2002

(54) Right reading magnetic compass

(76) Inventor: David D. Barker, Greenacres, WA (US)

Correspondence Address: Patent Law & Venture Group, Suite K-105, 3151 Airway Ave., Costa Mesa, CA, 92626, US

(21) Appl. No.: 09/780,116

(22) Filed: Feb. 8, 2001

(51) Int. Cl. G01C 17/22

(52) U.S. Cl. 33/355 R; 33/348

(57) ABSTRACT

An direction determining instrument provides an image reversing device positioned for siting a fixed indicator indicia and a mirror image reversed compass rose supported for rotation about its center. The compass rose is enabled by a magnetic device such as a magnet, for seeking magnetic north. The image reversing device, compass rose, and fixed indicator indicia are arranged and positioned so that the fixed indicator indicia and the rotatable mirror imaged compass rose are visible in the image reversing device as a non-reversed compass rose superimposed on the indicator indicia such that rotation of the compass rose appears to move in the direction of rotation of the instrument.

### BACKGROUND OF THE INVENTION

1. Field of the Invention

This invention relates generally to navigation instruments and more particularly to an instrument for indicating direction such as a compass.

2. Description of Related Art

The following art defines the present state of this field:

Morris et al., U.S. Pat. No. 3,023,512 describes an antifriction mounting comprising a container presenting a spherical surface non-wettable by mercury, a pool of mercury in said container, and a float assembly floating on said pool of mercury with its center of gravity above its center of buoyancy, said float assembly presenting to the surface of the mercury a solid surface having wettable and non-wettable areas, and said mercury having a meniscus that is concave upwardly at a line of contact of said mercury surface and said wettable solid surface area, the solid surface presented to the mercury being provided by a ring having its interior surface non-wettable by mercury and its exterior surface wettable by mercury.

Albers, U.S. Pat. No. 3,574,283 describes a simulated visual reference collimated heads-up display system for aircraft pilots arranged in the pilot's normal line of sight through the windshield and utilizing the established basic theories and principals of flight enabling a pilot, even an inexperienced pilot, to fly safely and with precision, maintaining good air speed and attitude control in clear visual references flying weather or in instrument or marginal weather conditions. The system employs reticle plate images projected on a screen disposed in the pilot's normal line of vision and comprising a horizon line image slaved to the aircraft's gyro horizon instrument; and attitude circle image fixedly related to the vertical centerline of the screen for selective positioning along the vertical centerline of the screen to depict the optimum nose attitude of the aircraft to be maintained for a selected mode of flight; a small airplane image fixedly related to the display screen and to the aircraft to depict the instantaneous pitch and bank attitudes and heading of the aircraft during all phases of flight including the takeoff and landing runs of the aircraft so the pilot can center the small airplane image in the attitude circle to establish the optimum nose attitude of the aircraft during any selected mode of flight; air speed and vertical speed line images pivoted to swing up and down about the ends of the wings of the small airplane image and slaved to the aircraft's air speed and vertical speed instruments to indicate deviations from the optimum air speed and rate-of-climb or descent to be maintained at a selected mode of flight depicted by lateral alignment of the swinging line images to the respective wing portions of the small airplane image; and altitude display slaved to the aircraft's altimeter in a manner to move up or down over the screen when a deviation of selected magnitude in either direction from a preselected altitude to be maintained in a selected mode of flight occurs, and also arranged to indicate arrival at a planned or assigned altitude when climbing or on descent this indication being given by the altitude display moving up or down over the display screen, and also arranged to indicate arrival at the prescribed ILS minimum altitude when making ILS (Instrument Landing System) approach to a landing; a yaw display slaved to the aircraft's yaw rate gyro system in a manner to move in from the right or in from the left over the screen when yawing of the aircraft occurs; a direction line image vertically related to the screen and selectively slaved to a compass and a compass bug settable to a desired heading by the pilot or to the Omnisignal or Localizer signal of the aircraft's Omnireceiver or Localizer receiver so the pilot can steer the small airplane image to laterally center it on the direction line image to maintain the selected heading; and an ILS circle image slaved to follow the indications of the aircraft's standard cross-pointer indicator instrument arranged to replace the attitude circle image when the pilot wants to make an ILS instrument landing approach and have the simulated visual reference flying display for guidance in maintaining optimum instrument flight using the same reference images and procedures.

Lunetta, U.S. Pat. No. 4,114,997 describes a film projection device having a screen, light source, lens and mirror system and a reference indicator disposed immediately in front of the mirror for shadow casting a reference line onto the image of a film projected onto the screen via initial projection onto the mirror.

Setter et al., U.S. Pat. No. 4,327,498 describes a magnetic compass compensation system suitable for use within a ferrous land vehicle, a secondary magnetic sensor senses, the total magnetic field as components along a three axis system drawn vertical, lateral and transverse to the ferrous vehicle. Compensation signals corresponding to the permanent and induced magnetic fields of the vehicle are isolated from the total magnetic field. The compensation signals are applied to compensation coils surrounding a primary magnetic sensor for providing an output equivalent to the horizontal components of the earth's undisturbed magnetic field.

Whitman, III, U.S. Pat. No. 4,763,419 describes an optical viewing system, which is preferably a compass which eliminates the parallax and sighting problems of prior art optical systems. The compass includes a beam splitter which displays a sighted image both on a reference screen and a free-floating magnetized sphere or other moving surface. The sighted image on the reference screen and on the sphere are superimposed upon each other when viewed through one facet of the beam splitter. In this manner parallax is eliminated, thus the direction and elevation of the image may be readily and accurately determined.

The prior art teaches the use of a mirror sited instrument image, magnetic compasses, optical viewing systems, visual reference collimated heads-up display systems and a fluid floated compass. However, the prior art does not teach the present combination of simple and low cost construction and use. The present invention fulfills these needs and provides further related advantages as described in the following summary.

### SUMMARY OF THE INVENTION

The present invention teaches certain benefits in construction and use which give rise to the objectives described below.

A direction determining instrument having advantages in simple construction and convenienc of use and which provides an image reversing device positioned for siting a fixed indicator indicia and a mirror image reversed compass rose supported for rotation about its center. The compass rose is enabled by a magnetic device such as a magnet, for seeking magnetic north. The image reversing device, compass rose, and fixed indicator indicia are arranged and positioned so that the fixed indicator indicia and the rotatable mirror imaged compass rose are visible in the image reversing device as a non-reversed compass rose superimposed on the indicator indicia such that rotation of the compass rose appears to move in the direction of rotation of the instrument.

A primary objective of the present invention is to provide a direction indicating instrument having advantages not taught by the prior art.

Another objective is to provide such an invention capable of moving in the direction that the instrument is turning.

A further objective is to provide such an invention having simple and low cost construction.

A still further objective is to provide such an invention capable of operation in a ruggedized construction for rough handling.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective exploded view from above of the preferred embodiment of the invention;

FIG. 2 is similar thereto but shown from a lower perspective;

FIG. 3 is a side elevational view thereof showing the invention as vertically aligned;

FIG. 4 is similar thereto but shown slightly out of vertical alignment;

FIG. 5 is front elevational view thereof showing the invention in a magnetic north aligned attitude;

FIG. 6 is similar thereto showing the instrument as rotated in a westerly direction;

FIG. 7 is a perspective exploded view of a further embodiment of the invention as seen from above;

FIG. 8 is a partial perspective exploded view thereof as seen from below; and

FIG. 9 is a side elevational view thereof with portions broken-away to reveal interior details.

### DETAILED DESCRIPTION OF THE INVENTION

The above described drawing figures illustrate the invention, an instrument apparatus for indicating direction.

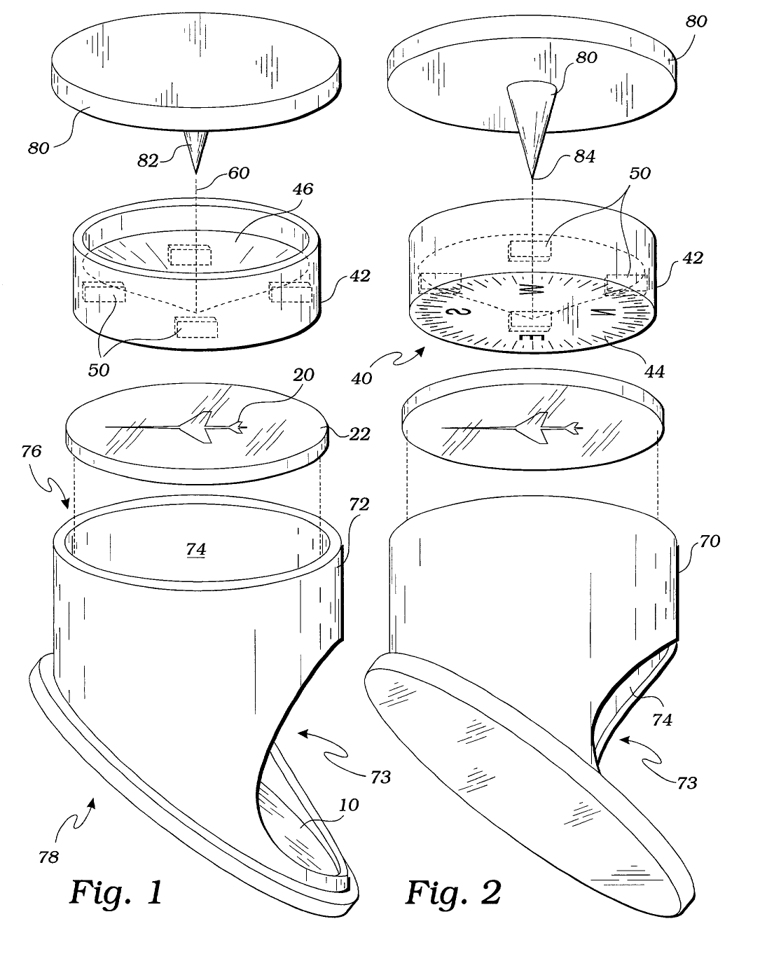

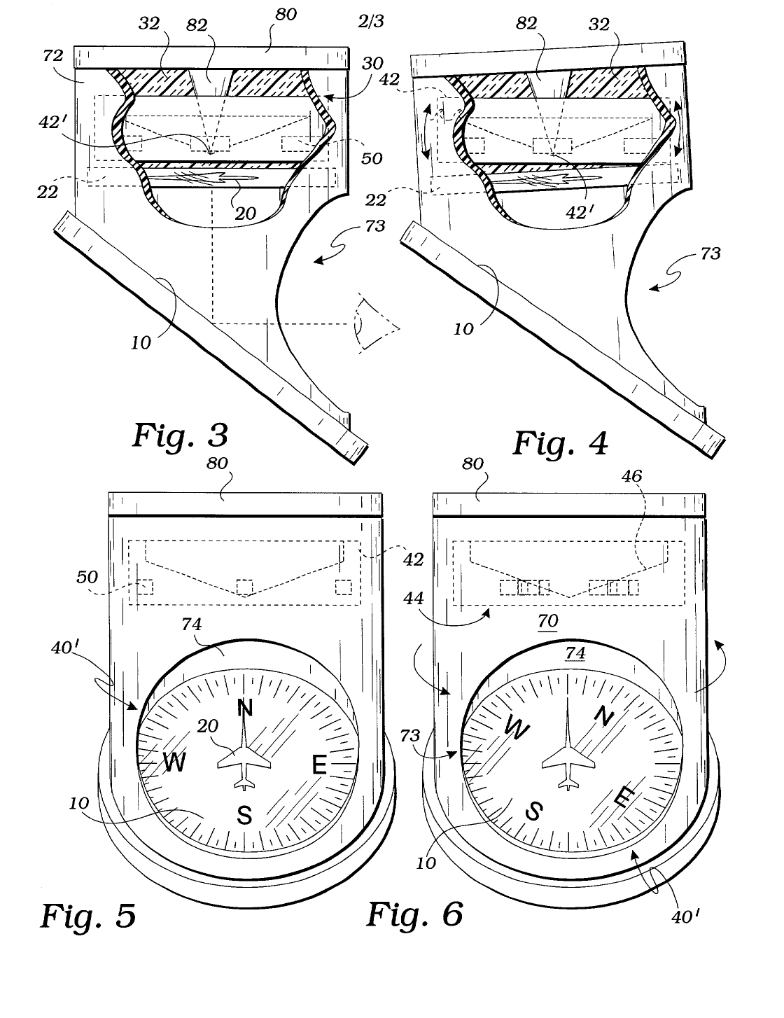

The instrument apparatus, in a first embodiment, shown in FIGS. 1-6, comprises an image reversing means 10, such as the mirror surface shown or any other optical device for providing a mirror image relationship, positioned for sighting on a fixed indicator indicia 20, and a supporting means 30 enabled for supporting a mirror-image reversed compass rose 40 for rotation about a center point 42′ thereof, the compass rose 40 enabled, by a magnetic field producing means 50 for seeking the magnetic north direction. The image reversing means 10, fixed indicator indicia 20, supporting means 30, and compass rose 40, are arranged and positioned, as shown in the figures, whereby the fixed indicator indicia 20 and the rotatable mirror-imaged compass rose 40 are visible in the image reversing means 10 as a non-reversed compass rose 40′ superimposed on the indicator indicia 20 such that rotation of the compass rose 40 appears to move in the direction of rotation of the instrument when the instrument is rotated about its own vertical axis 60. This is illustrated in FIG. 6.

To further define the invention, it is clear from the figures that the instrument apparatus comprises the mirrored surface 10 positioned for siting through a transparent plate 22, the plate providing the indicator indicia 20 as etched, stenciled or otherwise placed thereon. Preferably, the support means 30 is filled with a buoyant fluid 32 which supports a buoyant, cup-shaped, body 42 floating above the transparent plate 22. Such a fluid 32 may be water, alcohol, oil or any other fluid that is clear and able to buoy a body placed therein. The mirror-image reversed compass rose 40 is preferably imprinted on the buoyant body 42. The buoyant body 42 provides a downwardly facing surface 44 which supports, or is imprinted in any manner with the mirror-image compass rose 40. Together, the buoyant body 42 and imprinted compass rose 40, may be referred to as the compass rose, and it will be assumed that the reader will understand that the compass rose is an abstraction but meant to infer the moving member of the present invention.

Clearly it is desired to allow the buoyant body 42 to rotate and, to some extent, tilt within the buoyant fluid as the invention is meant to be mounted in a vehicle, such as an aircraft, that may change its attitude in three dimensional space. Other adaptations of the present invention may be made so that the vehicle may take dramatic attitude changes while still allowing the instrument to operate. In the preferred embodiment the buoyant body 42 is able to rotate 360 degrees and tilt a few degrees in any direction. Rotation is restricted to take place about a fixed central point 42 of the buoyant body 40. In this manner, the fixed indicator indicia 20 and the rotatable mirror imaged compass rose 40 are visible in the mirrored surface 10 as a non-reversed compass rose 40′ superimposed on the indicator indicia 20 such that rotation of the buoyant body 42 appears in the mirrored surface 10 to move in the direction of rotation of the instrument.

To further still define the preferred embodiment, as shown in the figures, and provide a more complete enablement to one of skill in the field of the invention, the support means 30 which is a cylindrical enclosure has a vertical longitudinal axis 60 providing a side wall 72 with an interior sidewall surface 74 defining an open upper end 76 and a closed lower end 78 thereof, the closed lower end 78 providing the planar mirrored surface 10 facing the interior sidewall surface 74 at an approximately 45 degree angle with respect to the longitudinal axis 60. The side wall 72 further provides an aperture 73 positioned for viewing the mirrored surface 10 from without the cylindrical enclosure 70, i.e., by siting through the aperture 73.

The transparent plate 22 is positioned horizontally as shown and forms a liquid tight seal with the interior sidewall surface 74, the transparent plate 22 providing the fixed indicator indicia 20 thereon. The indicator indicia 20 is visible in the mirrored surface 10 from without the cylindrical enclosure 70 by siting through the aperture 73. The buoyant fluid 32 is supported above the transparent plate 22 and is enclosed by the side wall 72. The magnetic north seeking means 50 is preferably one or more permanent magnets attached to the buoyant body 42 so that it attempts to always orient itself with the magnetic north. The buoyant body 42 provides a planar downwardly facing surface 44 which supports the mirror image of a compass rose 40 thereon and, in opposition thereto, a concave conical upfacing surface 46 defining an apex 42′, as shown in FIG. 4, at a vertical center of mass of the buoyant body 42.

An enclosure cap 80 is sealed to the open upper end 76 of the cylindrical enclosure 70, the cap 80 providing a centrally positioned downwardly extending finger 82 with a point 84 at the downwardly extending terminal end of the finger 82. This is most clearly shown in FIG. 2. The finger point 84 is positioned within the apex 42′ of the buoyant body 42 enabling the buoyant body to freely rotate about the finger point 84 within the buoyant fluid 32. The buoyant body 42 is buoyed upwardly in the buoyant fluid 32 so that the apex 42′ is pressed against the point 84 and forces the buoyant body 42 to remain in a centered position within the enclosure 70. The fixed indicator indicia 20 and the rotatable mirror imaged compass rose 40 are visible in the mirrored surface 10 as a non-reversed compass rose 40′ superimposed on the indicator indicia 20 such that rotation of the buoyant body 42 appears in the mirrored surface 10 to move in the direction of rotation of the instrument.

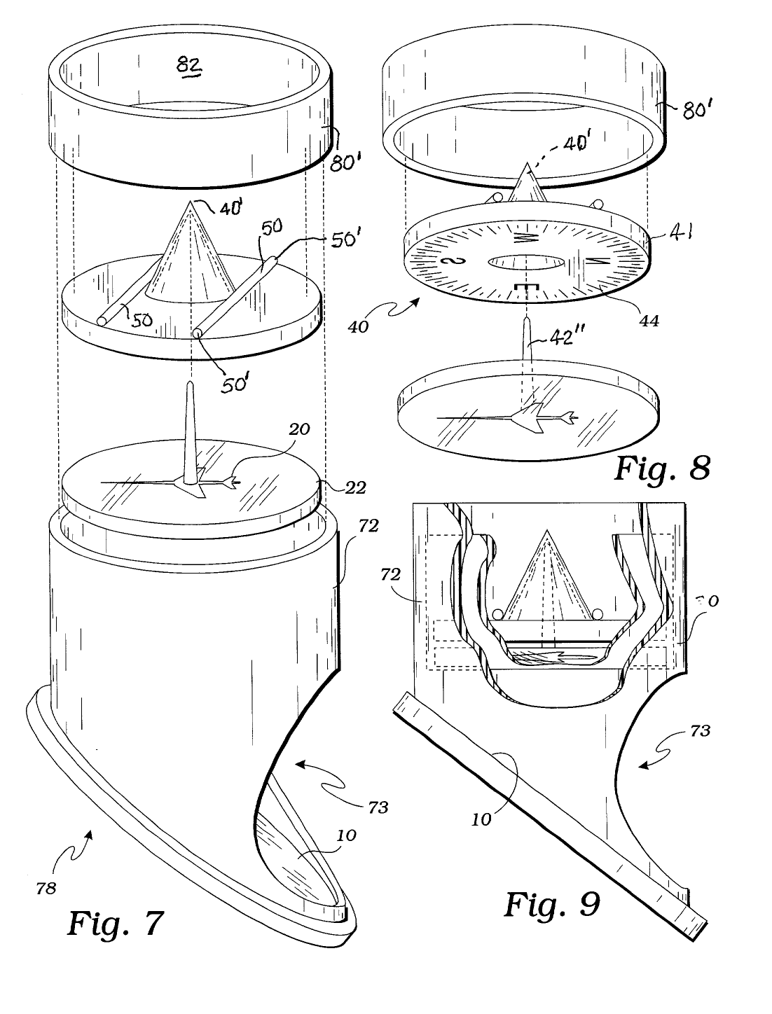

In a further embodiment shown in FIGS. 7-9, the instrument apparatus comprises the image reversing means 10, and the supporting means 30 enabled for supporting the mirror-image reversed compass rose 40 of disk 41 for rotation about a finger 42″ extending upwardly from transparent plate 22. Thereof, the compass rose 40 is enabled, by a magnetic field producing means 50 for seeking the magnetic north direction. The image reversing means 10, fixed indicator indicia 20, supporting means 30, and compass rose 40, are arranged and positioned, as shown in the figures, whereby the fixed indicator indicia 20 and the rotatable mirror-imaged compass rose 40 are visible in the image reversing means 10 as a nonreversed compass rose 40′ superimposed on the indicator indicia 20 such that rotation of the compass rose 40 appears to move in the direction of rotation of the instrument when the instrument is rotated about its own vertical axis 60. This is illustrated in FIG. 6.

Clearly it is desired to allow the disk 41 to rotate and, to some extent, tilt on the finger 42″ as the invention is meant to be mounted in a vehicle, such as an aircraft, that may change its attitude in three dimensional space. Other adaptations of the present invention may be made so that the vehicle may take dramatic attitude changes while still allowing the instrument to operate. In the preferred embodiment the disk 41 is able to rotate 360 degrees and tilt a few degrees in any direction. Rotation is restricted to take place about a fixed central point 40′ within a cone mounted on disk 41. In this manner, the fixed indicator indicia 20 and the rotatable mirror imaged compass rose 40 are visible in the mirrored surface 10 as a nonreversed compass rose 40′ superimposed on the indicator indicia 20 such that rotation of the disk 41 appears in the mirrored surface 10 to move in the direction of rotation of the instrument itself. An aluminum metal ring 80′ is positioned so as to provide eddy current damping of motion due to a close proximity of the terminal ends 50′ of magnets 50 to the interior wall surface 82 of ring 80′.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An instrument apparatus for determining magnetic north, the apparatus comprising:
An image reversing means positioned for siting a fixed indicator indicia;
a supporting means enabled for supporting a mirror image reversed compass rose for rotation about a center thereof, the compass rose enabled, by a magnetic field producing means for seeking magnetic north;
the image reversing means, supporting means, compass rose, and fixed indicator indicia arranged and positioned for enabling the fixed indicator indicia and the rotatable mirror imaged compass rose to be visible in the image reversing means as a non-reversed compass rose superimposed on the indicator indicia such that rotation of the compass rose appears to move in the direction of rotation of the instrument when the instrument is rotated about a vertical axis in space.

2. An instrument apparatus for determining magnetic north, the apparatus comprising:
a mirrored surface positioned for siting through a transparent plate, the plate providing an indicator indicia thereon;
a buoyant fluid supported above the transparent plate;
a magnetic north seeking buoyant body floated within the buoyant fluid, the buoyant body providing a downwardly facing surface providing a mirror image of a compass rose thereon;
a means for restricting motion of the buoyant body to simple rotation about a fixed central point of the buoyant body;
whereby the fixed indicator indicia and the rotatable mirror imaged compass rose are visible in the mirrored surface as a non-reversed compass rose superimposed on the indicator indicia such that rotation of the buoyant body appears in the mirrored surface to move in the direction of rotation of the instrument when the instrument is rotated about the vertical axis in space.

3. An instrument apparatus for determining magnetic north, the apparatus comprising:
a cylindrical enclosure having a vertical longitudinal axis and providing a side wall with an interior sidewall surface defining an open upper end of the enclosure and a closed lower end thereof, the closed lower end providing a planar mirrored surface facing the interior sidewall surface at a 45 degree angle with respect to the longitudinal axis, the side wall further providing an aperture positioned for viewing the mirrored surface from without the cylindrical enclosure;
a transparent plate positioned horizontally and forming a liquid tight seal with the interior sidewall surface, the transparent plate providing a fixed indicator indicia thereon, the indicator indicia visible in the mirrored surface from without the cylindrical enclosure;
a buoyant fluid supported above the transparent plate;
a magnetic north seeking buoyant body floated within the buoyant fluid, the buoyant body providing a planar downwardly facing surface providing a mirror image of a compass rose thereon and, in opposition thereto, a concave conical upfacing surface defining an apex at a vertical center of mass of the buoyant body;
an enclosure cap sealed to the open upper end of the cylindrical enclosure, the cap providing a downwardly extending finger with a point at the downwardly extending terminal end of the finger, the finger point positioned within the apex of the buoyant body enabling the buoyant body to freely rotate about the finger point within the buoyant fluid;
whereby the fixed indicator indicia and the rotatable mirror imaged compass rose are visible in the mirrored surface as a non-reversed compass rose superimposed on the indicator indicia such that rotation of the buoyant body appears in the mirrored surface to move in the direction of rotation of the instrument when the instrument is rotated about the vertical axis in space.

4. An instrument apparatus for determining magnetic north, the apparatus comprising:
a mirrored surface positioned for siting through a transparent plate, the plate providing an indicator indicia thereon;
a magnetic north seeking disk providing a downwardly facing surface providing a mirror image of a compass rose thereon;
a means for restricting motion of the disk to simple rotation about a fixed central point of the a cone mounted on the disk; and
an aluminum ring positioned for eddy current motion damping of the disk;
whereby the fixed indicator indicia and the rotatable mirror imaged compass rose are visible in the mirrored surface as a non-reversed compass rose superimposed on the indicator indicia such that rotation of the buoyant body appears in the mirrored surface to move in the direction of rotation of the instrument when the instrument is rotated about the vertical axis in space.
